(19) United States
(12) Patent Application Publication
(10) Pub. No.: US 2020/0114921 A1
(43) Pub. Date: Apr. 16, 2020

(54) SENSOR-LIMITED LANE CHANGING

(71) Applicant: Ford Global Technologies, LLC, Dearborn, MI (US)

(72) Inventors: KYLE SIMMONS, New Boston, MI (US); HONGTEI ERIC TSENG, Canton, MI (US); THOMAS EDWARD PILUTTI, Ann Arbor, MI (US)

(73) Assignee: Ford Global Technologies, LLC, Dearborn, MI (US)

(21) Appl. No.: 16/157,889

(22) Filed: Oct. 11, 2018

(51) Int. Cl. B60W 30/18; G05D 1/02; G05D 1/00

(52) U.S. Cl. CPC B60W 30/18163; G06F 17/30595; G05D 1/0088; G05D 1/0257

(57) ABSTRACT

Upon receiving a request to change lanes in a vehicle, a computer can determine that a first sightline toward a target lane is blocked, and can control the vehicle to move laterally in a current lane to obtain a second sightline toward the target lane.

### BACKGROUND

Vehicle sensors can perceive the world around a vehicle. However, vehicle sensors have physical limitations, including a limited sensing range. For example, a host vehicle's rear corner radar may have a sensing limit of fifty meters. Such a radar therefore cannot detect an object such as another vehicle that is more than fifty meters behind the host vehicle. Further, a sensor's range or capability to perceive data in certain locations may be reduced by objects surrounding the host vehicle, e.g., causing blockages hence blind spots.

### BRIEF DESCRIPTION OF THE DRAWINGS

FIG. 1 is a block diagram of an example vehicle.

FIG. 2 is a top view of a vehicle on a road, illustrating example sensor sightlines.

FIG. 3 is a top view of a vehicle on a road illustrating an example scenario in which a vehicle computer may evaluate a possible lane change.

FIGS. 4A-4C continue the example scenario of FIG. 3, including illustrating lateral movement of the vehicle to obtain different sensor sightlines.

FIG. 5 illustrates an example process for a vehicle to determine to change and/or to change lanes.

FIG. 6 illustrates an example process for a vehicle to determine to change and/or to change lanes.

### DETAILED DESCRIPTION

A method comprises, upon receiving a request to change lanes, determining that a first sightline toward a target lane is blocked; and controlling a vehicle to move laterally in a current lane to obtain a second sightline toward the target lane. The method can further comprise determining, after the vehicle has moved laterally in the current lane, that the second sightline is blocked; and then suppressing the request to change lanes. The method can further comprise determining, after the vehicle has moved laterally in the current lane, that the second sightline is clear; and then controlling the vehicle to move to the target lane. The method can further comprise determining whether the second sightline is clear for a range of a sensor from which the second sightline originates. The range can be determined based in part on an ambient condition. The range can be determined based in part on a predicted maximum deceleration of a second vehicle in the target lane. The first and second sightline can originate from a sensor mounted to the vehicle. The sensor can be a radar. The method can further comprise, before determining that the first sightline is blocked, that the vehicle is travelling above a specified velocity. The request to change lanes can be provided from a computer in the vehicle without user input.

A system comprises a computer including a processor and a memory, the memory storing instructions executable by the processor to: upon receiving a request to change lanes, determine that a first sightline toward a target lane is blocked; and control a vehicle to move laterally in a current lane to obtain a second sightline toward the target lane. The instructions can further comprising instructions to determining, after the vehicle has moved laterally in the current lane, that the second sightline is blocked; and then suppressing the request to change lanes. The instructions can further comprising instructions to determine, after the vehicle has moved laterally in the current lane, that the second sightline is clear; and then control the vehicle to move to the target lane. The instructions can further comprise instructions to determine whether the second sightline is clear for a range of a sensor from which the second sightline originates. The range can be determined based in part on an ambient condition. The range can be determined based in part on a predicted maximum deceleration of a second vehicle in the target lane. The first and second sightline can originate from a sensor mounted to the vehicle. The sensor can be a radar. The instructions can further comprising instructions to, before determining that the first sightline is blocked, that the vehicle is travelling above a specified velocity. The request to change lanes can be provided from a computer in the vehicle without user input.

To expand and enhance an ability of an autonomous or semi-autonomous vehicle to change lanes on a road, and to address the problem of occluded or blocked vehicle sensors, a vehicle computer can be programmed to reposition a vehicle to obtain a clear line of sight into an adjacent or target lane. The vehicle computer may determine to attempt a lane change of the vehicle, and can then determine whether a clear line of sight exists into the adjacent lane. For example, a rearward or following vehicle in a same lane as a host vehicle could block a line of sight from the host vehicle. The host vehicle could then laterally move, i.e., from left to right or vice versa, in a current lane to reposition the host vehicle to obtain a better line of sight. If the host vehicle is able to obtain a clear line of sight into the adjacent or target lane, the host vehicle can then change lanes.

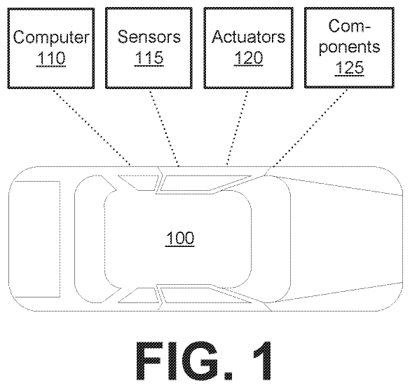

FIG. 1 illustrates an example vehicle 100 which is typically a machine-powered land vehicle such as a car, truck, etc. The vehicle 100 is sometimes referred to herein as a “host” vehicle 100 to differentiate the vehicle 100 from other vehicles 105, i.e., target vehicles 105 that, from the perspective of the host vehicle 100, are objects or targets to be avoided and/or considered in vehicle 100 path planning and/or navigation.

The vehicle 100 includes a vehicle computer 110, sensors 115, actuators 120 to actuate various vehicle components 125, and a vehicle communications module 130. Via a network 135, the communications module 130 allows the vehicle computer 110 to communicate with one or more data collection or infrastructure nodes, other vehicles, and/or one or more remote computer servers, e.g., according to vehicle-to-vehicle or vehicle-to-infrastructure communications systems.

The computer 110 includes a processor and a memory such as are known. The memory includes one or more forms of computer-readable media, and stores instructions executable by the computer 110 for performing various operations, including as disclosed herein.

The computer 110 may operate a vehicle 100 in an autonomous, a semi-autonomous mode, or a non-autonomous (or manual) mode. For purposes of this disclosure, an autonomous mode is defined as one in which each of vehicle 100 propulsion, braking, and steering are controlled by the computer 110; in a semi-autonomous mode the computer 110 controls one or two of vehicles 105 propulsion, braking, and steering; in a non-autonomous mode a human operator controls each of vehicle 100 propulsion, braking, and steering.

The computer 110 may include programming to operate one or more of vehicle 100 components 125, e.g., brakes, propulsion (e.g., control of acceleration in the vehicle by controlling one or more of an internal combustion engine, electric motor, hybrid engine, etc.), steering, climate control, interior and/or exterior lights, etc., as well as to determine whether and when the computer 110, as opposed to a human operator, is to control such operations. Additionally, the computer 110 may be programmed to determine whether and when a human operator is to control such operations.

The computer 110 may include or be communicatively coupled to, e.g., via a vehicle 100 communications bus or other vehicle 100 wired or wireless network, more than one processor, e.g., included in electronic controller units (ECUs) or the like included in the vehicle for monitoring and/or controlling various vehicle components 125, e.g., a powertrain controller, a brake controller, a steering controller, etc. The computer 110 is generally arranged for communications on a vehicle communication network that can include a communications bus in the vehicle such as a controller area network (CAN) or the like, and/or other wired and/or wireless mechanisms.

Via the vehicle 100 network, the computer 110 may transmit messages to various devices in the vehicle and/or receive messages from the various devices, e.g., sensors 115, an actuator 120, a human machine interface (HMI), etc. Alternatively or additionally, in cases where the computer 110 actually comprises a plurality of devices, the vehicle 100 communication network may be used for communications between devices represented as the computer 110 in this disclosure. Further, as mentioned below, various controllers and/or sensors 115 may provide data to the computer 110 via the vehicle communication network.

Vehicle 100 sensors 115 may include a variety of devices such as are known to provide data to the computer 110. For example, the sensors 115 may include Light Detection And Ranging (LIDAR) sensor(s) 115, etc., disposed on a top of the vehicle 100, behind a vehicle 100 front windshield, around the vehicle 100, etc., that provide relative locations, sizes, and shapes of objects surrounding the vehicle 100. As another example, one or more radar sensors 115 fixed to vehicle 100 bumpers may provide data to provide locations of the objects, second vehicles 105, etc., relative to the location of the vehicle 100. The sensors 115 may further alternatively or additionally, for example, include camera sensor(s) 115, e.g. front view, side view, etc., providing images from an area surrounding the vehicle 100, an ultrasonic sensor 115, etc.

Vehicle sensors 115 can have a maximum range, e.g., specified by a sensor 115 manufacturer. Further, the range can vary based on varying conditions, e.g., some sensors 115 operate differently depending on a level of ambient light, precipitation, fog, etc. The computer 110 can store a maximum sensing range for each of one or more sensors 115 included on a vehicle 100. Further, for each sensor 115, the computer 110 can store, for one sensor 115, multiple values for the maximum sensing range depending, e.g., on ambient conditions such as ambient temperature, ambient light, precipitation, etc. For example, for a given sensor 115, such as a radar, lidar, ultrasound, etc., the computer 110 could store a table specifying respective maximum sensing ranges for various ambient conditions, i.e., ranges of temperature, light, amount of precipitation, etc., and also possibly type of precipitation, and possibly for one or more of these factors in combination with one another. Also, some factors may not be relevant for some sensors (e.g., radar typically doesn't depend on light).

The vehicle 100 actuators 120 are implemented via circuits, chips, or other electronic and or mechanical components that can actuate various vehicle subsystems in accordance with appropriate control signals as is known. The actuators 120 may be used to control components 125, including braking, acceleration, and steering of a vehicle 100.

In the context of the present disclosure, a vehicle component 125 is one or more hardware components, and any program instructions stored therein and/or executable thereby, that are adapted to perform a mechanical or electro-mechanical function or operation—such as moving the vehicle 100, slowing or stopping the vehicle 101, steering the vehicle 100, etc. Non-limiting examples of components 125 include a propulsion component (that includes, e.g., an internal combustion engine and/or an electric motor, etc.), a transmission component, a steering component (e.g., that may include one or more of a steering wheel, a steering rack, etc.), a brake component, a park assist component, an adaptive cruise control component, an adaptive steering component, a movable seat, etc.

In addition, the computer 110 may be programmed and otherwise configured (e.g., with appropriate hardware interface(s)) for communicating via a vehicle-to-vehicle communication module or interface 130 with devices outside of the vehicle 100, e.g., through wireless vehicular communication (e.g., vehicle-to-vehicle (V2V) communication, vehicle-to-infrastructure (V2I or V2X) communication, vehicle-to-cloud (V2C) communication, etc.), to an infrastructure node 140 (typically via direct radio frequency communications) and/or (typically via the network 135) a remote (i.e., external to the vehicle 100 and in a geographic location out of a line of sight (also referred to as a sightline) of the vehicle 100 and node 140) server 170. The module 130 could include one or more mechanisms by which the computers 110 of vehicles 105 may communicate, including any desired combination of wireless (e.g., cellular, wireless, satellite, microwave and radio frequency) communication mechanisms and any desired network topology (or topologies when a plurality of communication mechanisms are utilized). Exemplary communications provided via the module 130 include cellular, Bluetooth, IEEE 802.11, dedicated short range communications (DSRC), and/or wide area networks (WAN), including the Internet, providing data communication services.

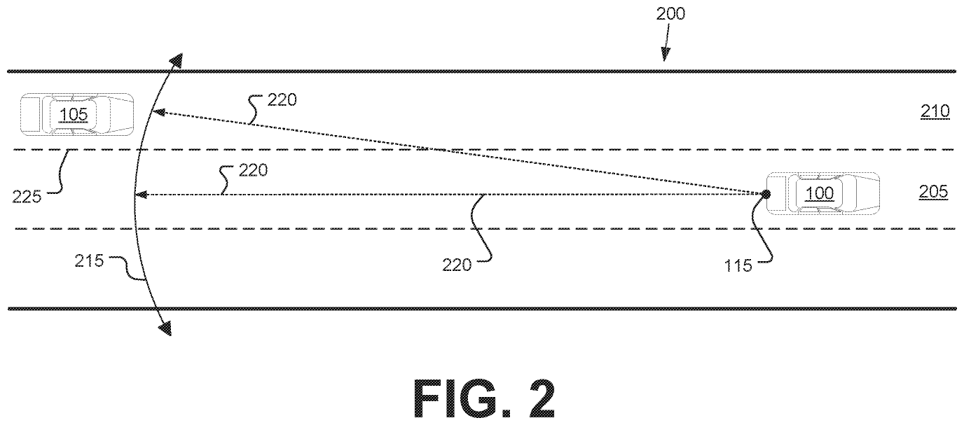

FIG. 2 is a top view of a vehicle 100 on a road 200. The vehicle 100 is shown operating in a current lane 205 of the road 200; discussed herein are scenarios for the vehicle 100 to change lanes to a target lane 210. To effect a lane change, the vehicle 100, operating with a sensor 115, such as a rear radar, cannot reliably receive data from beyond a sensing boundary 215 defined by a maximum sensing range of the sensor 115. Thus, the sensor 115 can detect objects (or the absence thereof) along a line of sight 220 that extends from the sensor 115 to the sensing boundary 215. FIGS. 2-4 each illustrate a single sensor 115 and, for the sensor 115, lines of sight 320. It will be appreciated that a sensor 115 could have an infinite number of lines of sight 220 that define a field of view. It will further be understood that different sensors can have different fields of view. For example, a lidar sensor can have up to a 360° field of view, while a radar sensor 115 mounted to face rearward of a vehicle 100 could have a 180° or less field of view. Rearward in the present context means behind a line defining a rear edge of a vehicle, or a line through a rear-most point on a vehicle.

A sensor 115 range r is a distance, e.g., measured in meters, within which the sensor 115 can reliably detect data. The range r is a distance at which a sensor 115 should be able to “see,” into an adjacent lane 210 to effect a lane change, e.g., a distance to a rear of a vehicle at which an object can be detected by solving for r in Equation (4) below. The range r is limited by a maximum sensing range of a sensor 115 that is specified by a sensor 115 manufacturer or supplier, or otherwise determined, e.g., based on empirical testing. However, the range r is often less than the maximum sensing range and, as can be seen from Equation (4), in many instances, e.g., depending on varying vehicle 100, 105 velocities, r may be a varying value.

A sensor 115 can obtain data for the computer 110 to determine whether the vehicle 100 can execute a lane change, e.g., from a current lane 205 to a target lane 210. In the example of FIG. 2, a target vehicle 105 is shown but it is not within the range r. Therefore, the vehicle 100 can safely change lanes if, at a current host vehicle 100 velocity, a target vehicle 105 at the sensing boundary 215, traveling at a specified velocity, could safely decelerate to avoid a rear-end collision with the host vehicle 100. Assuming that a sensor 115 used to detect a target vehicle 105 to the rear of a host vehicle 100 has a range r, we can determine as follows a host vehicle velocity vₕ at which, if no target vehicle 105 is detected in a target lane, a lane change can be executed.

First, assuming a maximum possible negative acceleration a of a target vehicle 105, i.e., a deceleration limit or maximum deceleration that the target vehicle can apply given its current velocity a current road friction, etc., then assuming a target vehicle 105 has an initial velocity vᵢ, then a final vehicle 105 velocity v_{f} after a time t has elapsed is given by:

v_{f}=vᵢ+a*t (1).

It follows that:

$$t = \frac{{v}_{f} - {v}_{i}}{a} . \qquad ( 2 )$$

Then, a distance d that the host and target vehicle 100, 105 will travel over the time t can be predicted by substituting from (2) above into the following:

$$d = \frac{{v}_{i} + {v}_{f}}{2} * t . \qquad ( 3 )$$

Then, based on a sensor 115 range r, and assuming a maximum target vehicle 105 velocity vₜ, it is possible to determine a threshold host vehicle 100 velocity vₕ at which, if no target vehicle 105 is detected in a target lane 210 within the sensing boundary 215, then the host vehicle 100 may safely chance lanes:

$${v}_{h} * t + r = \frac{{v}_{t} + {v}_{h}}{2} * t . \qquad ( 4 )$$

For example, assume that a maximum possible initial velocity vᵢ of a target vehicle 105 is 36 meters per second (m/s), i.e., approximately 80 miles per hour, which is a velocity above which most human drivers would not timely detect an oncoming rearward target vehicle 105 in a target lane 210. Further assume that the range r is 50 meters, and the deceleration limit a is 2.5 ^{m}/s. Then the minimum host vehicle velocity vₕ to provide a safe lane change is 20.2^{m}/s, i.e., approximately forty-five miles per hour.

Thus, with respect to FIG. 2, assume that the vehicle 100 is traveling in excess of forty-five miles per hour on the current lane 205, and that any target vehicle 105 on the target lane 210 rearward of the vehicle 100 is beyond the sensing boundary 215. Further, the vehicle 100, from a rear-mounted sensor 115, has clear lines of sight 220 all the way to the boundary 215 in each of the lanes 205, 210. If the sensing boundary 215 is greater than r=50 meters, then a vehicle 100 computer 110 could determine that the vehicle 100 can safely change from the current lane 205 to the target lane 210. On the other hand, if the vehicle 100 in the example of FIG. 2 were traveling at, e.g., thirty-five miles per hour, the computer 110 could be programmed to prevent the lane change upon detecting no rearward vehicle(s) 105 in the target lane 210.

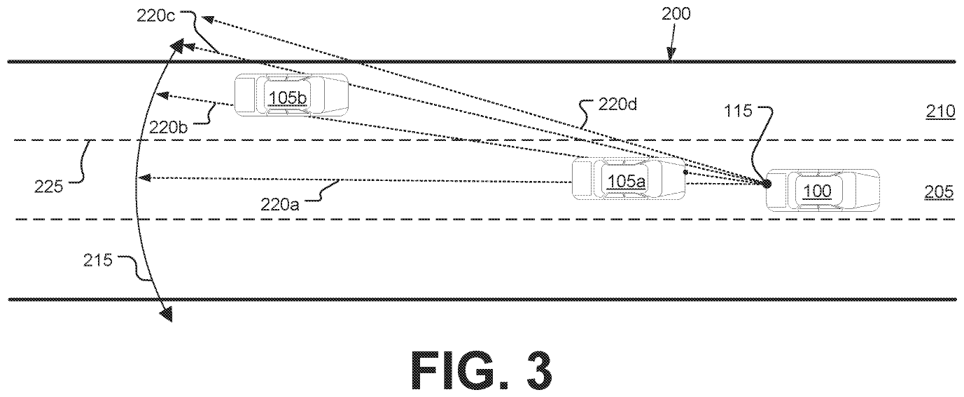

FIG. 3 illustrates a scenario in which a host vehicle 100 is travelling in a lane 205, wherein a computer 110 may evaluate a possible lane change. The vehicle 110 computer, receiving data from a rear sensor 115 data collected along a sightline 220a, can detect a first rearward vehicle 105a in the lane 205. Further, a second rearward vehicle 105b is traveling in the target lane 210. However, lines of sight 220b, 220c on which the host vehicle 100 might detect the second target vehicle 105b are blocked by the first target vehicle 105a. Note that the sightlines 220b, 220c are provided as discrete examples, but in fact a set of sightlines 220 from the vehicle 100 sensor 115, which as illustrated would define a pie-shaped area, is sometimes referred to as a blocked or occluded area with respect to a sensor 115 field of view. In this example, sightlines to the vehicle 105b are blocked by the vehicle 105a, and the vehicle 105b is thus in an occluded area with respect to the host vehicle 100. Thus, even though the computer 110 in the example of FIG. 3 could determine that no target vehicle 105 is detected in the target lane 210, because the target vehicle 105b is blocked from view by the sensor 115, the computer 110 could further identify an occluded area within the sensing boundary 215 for which the presence or absence of a target vehicle 105 cannot be determined.

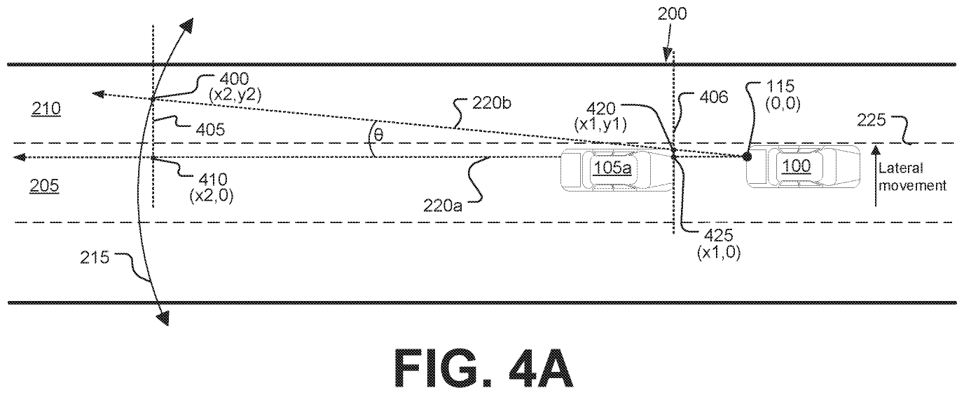

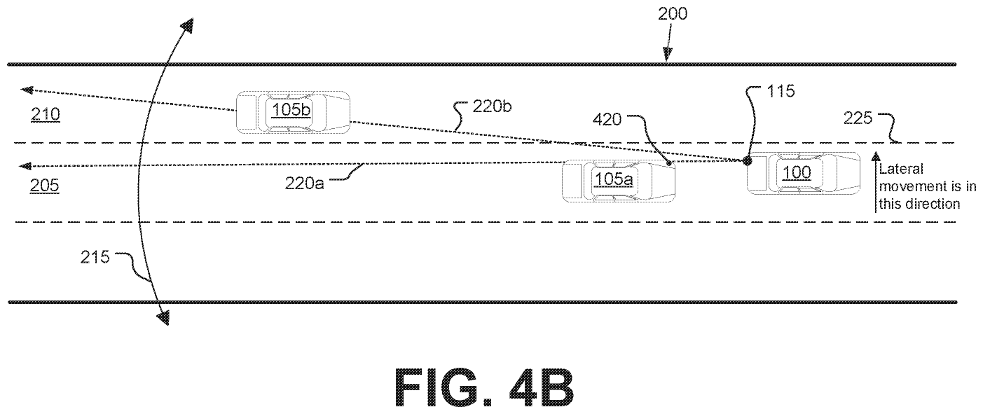

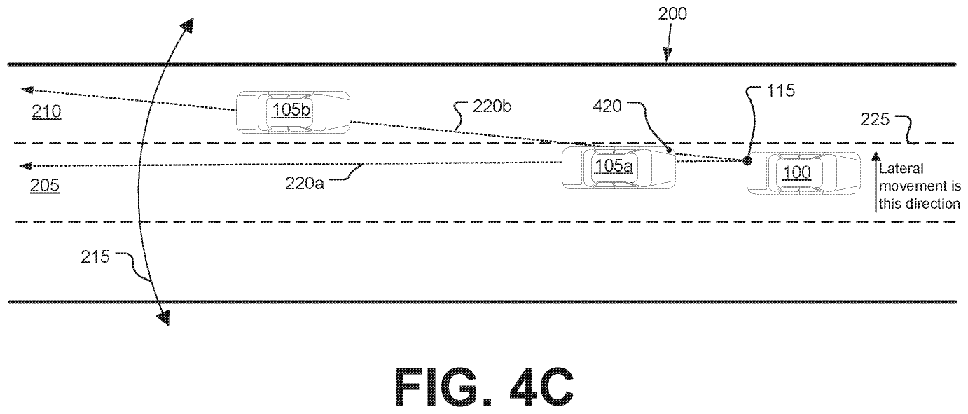

FIG. 4A continues the example of FIG. 3, illustrating a scenario in which a host vehicle 100 moves laterally in its current lane so that now the sensor 155 can detect the rearward target vehicle 105 in the target lane 210 along a line of sight 220b. The computer 110 can determine a lateral distance, i.e., an amount of lateral movement, for the vehicle 100 to obtain a clear line of sight 220b into a target lane 210. As indicated in FIG. 4A, lateral movement or distance in this context means movement of the vehicle 100 on a road 200 in a direction substantially perpendicular to a direction of travel along the road 200. For example, the vehicle 100 can move laterally, i.e., left or right, in a lane 205 to obtain the clear line of sight 220b.

The computer 110 can determine the amount of lateral movement by utilizing principles of Euclidean geometry. A range r can also be determined by geometric principles as described further below. For example, the computer 110 can be programmed to specify points on the road 200 relative to the vehicle 100 according to a coordinate system used by the computer 110, e.g., a two-dimensional Cartesian coordinate system or the like. Further, a sensor 115, e.g., a radar, mounted facing rearward on the vehicle 100 can be assigned a point in the coordinate system. To determine to execute a lane change maneuver, the computer 110 should obtain a clear line of sight 220b in the target lane 210 extending for the range r.

Accordingly, a point 400 can be assigned on the sensing boundary 215 in the lane 210, e.g., the point 400 can be selected to maximize a likelihood of detecting a target vehicle 105 in the lane 210 including at or near the sensing boundary 215. For example, as illustrated in FIG. 4A, the point 400 can define a midpoint of the lane 210 (i.e., be halfway between respective left and right boundaries of the lane 210) and on an arc that is part of the boundary 215, the point 400 further being on a sightline 220b extending from the sensor 115 through a point 420 defining a front corner of a vehicle 105a in a same lane 105 as a host vehicle 100. Further, a line 405 can be drawn through the point 400 perpendicular to a longitudinal axis of the vehicle 100 for ease of illustration, shown as perpendicular to the sightline 220a, which is substantially parallel to the vehicle 100 longitudinal axis. The vehicle 100 can be laterally moved so that the sightline 220a intersects a point 410 on the line 405. The point 410 is defined according to a specified lateral distance from a boundary 225 between the lanes 205, 210. In an ideal or theoretical scenario, that lateral distance could be zero, i.e., the point 410 could lie on the boundary 225, but in practice a further distance, e.g., ½ meter, one meter, etc., may be specified to provide a safety margin, i.e., to keep the vehicle 100 from possibly violating the boundary 225, i.e., moving into the lane 210 when a lane change has not been determined to be executed.

As can be seen in FIG. 4A, the vehicle 100 is positioned so that the sensor 115 has unblocked lines of sight including the sightline 220b to the sensing boundary 215 in the target lane 210. That is, the computer 110 can determine that, when the vehicle 100 is laterally positioned so that the longitudinal line of sight 220a intersects the point 410, a line of sight 220b at an angle θ determined so that the line of sight 220b intersects with the point 400 and is unobstructed from the sensor 115 to the sensing boundary 215. That is, r, an angle between the sightlines 220a, 200b can be determined according to basic trigonometry.

For example, a Cartesian coordinate system could have a point of origin defined by the sensor 115. A point 425 on the x-axis with coordinates (x1,0) could be identified on the front edge of the vehicle 105a. Further, coordinates (x1, y1) of a front corner point 420 of a trailing vehicle 105a could be identified from sensor 115 data. Moreover, the computer 110, by knowing respective distances from the sensor 115 to each of the points 420, 425, and positing that a line 406 through the points 420, 425 forms a right angle with the line from the sensor 115 through the point 410, can determine a length of the segment of the line 406 between the points 420, 410, i.e., a distance y1 from the x-axis, i.e., from the point 425, could be determined from sensor 115 data and/or via the Pythagorean Theorem. Then, between a sightline 220a that is on the x-axis and a sightline 220b through the corner point 420, an angle θ_ could be determined as follows:

$$θ = {tan}^{- 1} \frac{y 1}{x 1} . \qquad ( 5 )$$

Further, e.g., based on stored data describing the lane 210 of the road 200, we know the length y2 of the segment 405, i.e., the distance from the x-axis to the center point 400 of the target lane 210, e.g., according to vehicle 100 sensor 115 data and/or stored road 200 map data. Once the angle 74 has been determined, x2, i.e., the x component of the coordinate of the point 400 on the sensing boundary 215, can be obtained as follows:

$$x 2 = \frac{y 2}{tan ( θ )} . \qquad ( 6 )$$

Because x2 and y2 are both now known, the Pythagorean theorem can now be used to determine a target lane sensing distance, i.e., a distance from the sensor 115 to the point 400 on the sensing boundary 215 in the target lane 210, i.e., the longest distance at which the sensor 115 can “see” to detect target vehicle 105 in the target lane 210. That is, x2 as determined in Equation (6) and as described above could be used as the range r, i.e., a distance that the vehicle 100 can “see” into an adjacent lane 210. That is, r as determined according to Equation (6) could be used in Equation (4) above to determine a threshold host vehicle 100 velocity vₕ to change lanes, and hence to determine whether at a current velocity, given the value for r, the vehicle 100 can change lanes.

In the example of FIG. 4A, the sightline 220b does not intersect any portion of the target vehicle 105a in the same lane 205 as the host vehicle 100, including a front corner point 420 of the target vehicle 105a. Further, the computer 110 detects no target vehicles 105 or other obstacles in the target lane 210 to indicate that a lane change should not be performed.

FIG. 4B is similar to FIG. 4A, including the target vehicle 105a not intersecting with the sightline 220b, but with a target vehicle 105b shown in the line of sight 220b, and with certain elements and labels from FIG. 4A removed for clarity of illustration. In the example of FIG. 4B, the host vehicle computer 110 could determine not to change lanes 205, 210 after laterally repositioning in the lane 205 and then detecting the vehicle 105b in the target lane 210.

FIG. 4C is also similar to FIG. 4A, but with the target vehicle 105a shown in the line of sight 220b, and with certain elements and labels from FIG. 4A removed for clarity of illustration. Thus, in the example of FIG. 4C, the target vehicle 105a in a current lane 205 with the host vehicle 100 prevents a lane change determination even after the host vehicle 100 has been laterally repositioned, i.e., in this example, moved closer to the lane boundary 225.

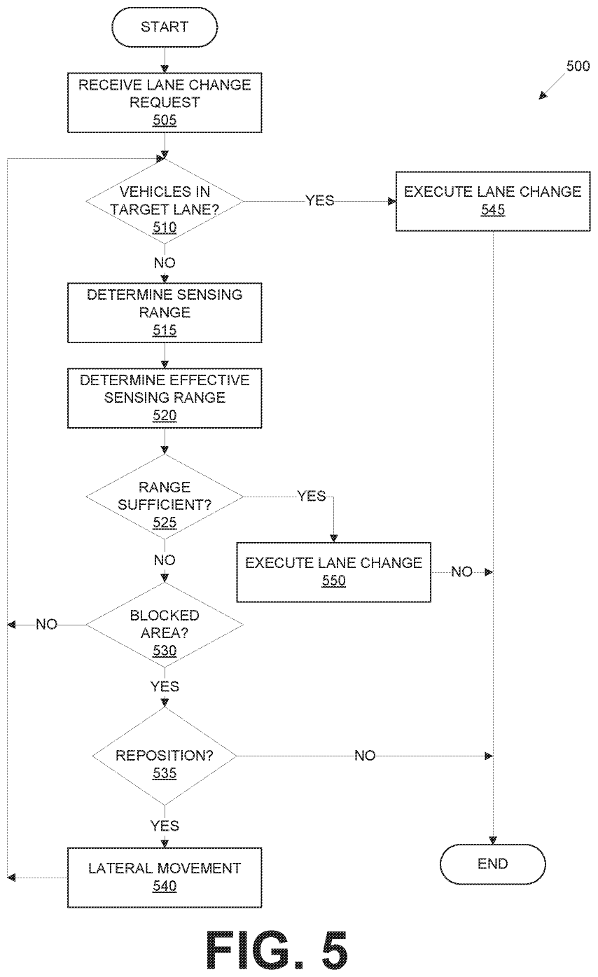

FIG. 5 illustrates an example process 500 for a host vehicle 100 to determine to change lanes 205, 210. For example, the process 500 could be executed by a processor of a vehicle 100 computer 110 according to instructions stored in a memory of the computer 110.

The process 500 begins in a block 505, in which the computer 110 receives a request to change lanes, whether from a user input or some other computer or program portion in the computer 110 has been received. For example, the vehicle 100 could be in a semi-autonomous mode, and the computer 110 could receive user input, e.g., by a vehicle 100 operator actuating a turn signal, via input to a human machine interface (HMI) in the vehicle 100 such as a touchscreen or microphone, etc. In another example, the computer 110 could be operating the vehicle 100 in a fully autonomous mode, and could determine to change lanes for a variety of path-planning and/or navigational goals, such as to optimize a vehicle 100 velocity, prepare for a vehicle 100 exit or turn from a road 200, avoid potholes, bumps, etc.

Next, in a block 510, the computer 110 determines whether one or more vehicles 105 are detected in a target lane 210. If yes then the process 500 can proceed to a block 545 for a lane change process to be carried out. If no, the process 500 continues in a block 515.

In the block 515, the computer 110 determines a required ranger, e.g., based on a vehicle 100 velocity according to Equation (4).

Next, in a block 520, the computer 110 determines an effective sensing range of a sensor 115 with respect to a target lane 210, i.e., a distance at which the sensor 115 is expected to detect objects in the lane 210. For instance, in the example of FIG. 4A, the effective sensing range is a distance between the sensor 115 and the point 400 on the sensing boundary 215. The effective sensing range could be based on a manufacturer-specified sensing range and/or could be determined dynamically, e.g., in substantially real time. For example, for a given sensor 115, the computer 110 could store a table or the like specifying sensor ranges and/or threshold velocities according to one or more environmental or ambient conditions, i.e., data specifying a physical condition around the vehicle 100 that may affect a sensing medium, environmental conditions possibly including ambient temperature, presence or absence of precipitation, amount of ambient light, presence of fog, etc. Based on a current vehicle 100 velocity and/or ambient conditions, the computer 110 could accordingly establish the effective sensing range.

Next, in a block 25, the computer 110 determines whether effective sensing range determined in the block 520 is sufficient, i.e., whether it is equal to or greater than the required range r. If yes, then the process 500 proceeds to a block 550. Otherwise, the process 500 proceeds to a block 530.

In the block 530, the computer 110 determines whether, for one or more sensors 115 facing rearward of the vehicle 100, there is a blocked area, i.e., blocked lines of sight 220 into a target lane 210, as described above. That is, the computer 110 could determine that a vehicle 105 to the rear of a host vehicle 100 is blocking lines of sight 220. If so, then the process 500 proceeds to a block 535 to determine if the vehicle 100 is to laterally move, i.e., reposition itself, in a current lane 205, whereby the vehicle 100 may be able to obtain a better sightline 220 into the target lane 210. Otherwise, the process 500 returns to the block 510.

In the block 535, the computer 110 determines whether the vehicle 100 can be repositioned, i.e., laterally moved, in a current lane 205, e.g., typically, toward an edge of the lane 205 bordering a target lane 210. In some cases, the vehicle 100 may be at or less than an acceptable margin of distance of the target lane 210, whereupon the computer 110 will determined that the vehicle 100 cannot be repositioned, and the process 500 ends. Otherwise, the process 500 proceeds to a block 540.

In the block 540, the computer 110 causes actuation of vehicle 100 components 120 effect lateral movement of the vehicle 100. For instance, in the examples of FIGS. 3-4, the computer 110 could actuate vehicle 101 steering to steer the vehicle to the left in a current lane 205. The computer 110 could be programmed to cause actuation of lateral movement until further lateral movement of the vehicle 100 would violate a lane 205 boundary 225, i.e., cross into a target lane 210 and/or avoid coming within a specified distance (i.e., a safety margin), e.g., one half meter, of the lane 205 boundary 225. Following the block 540, the process 500 returns to the block 510.

In a block 545, which may follow the block 510, the computer 110 executes a lane change process that can include a lane change if permitted by a virtual driver or the like programming based on detection of vehicles in a target lane 510. the process 500 then ends.

In a block 550, which may follow the block 525, the computer 110 actuates vehicle 100 components 125 to change lanes, an absence of vehicles 105 in a target lane 210 having been determined. The process 500 then ends.

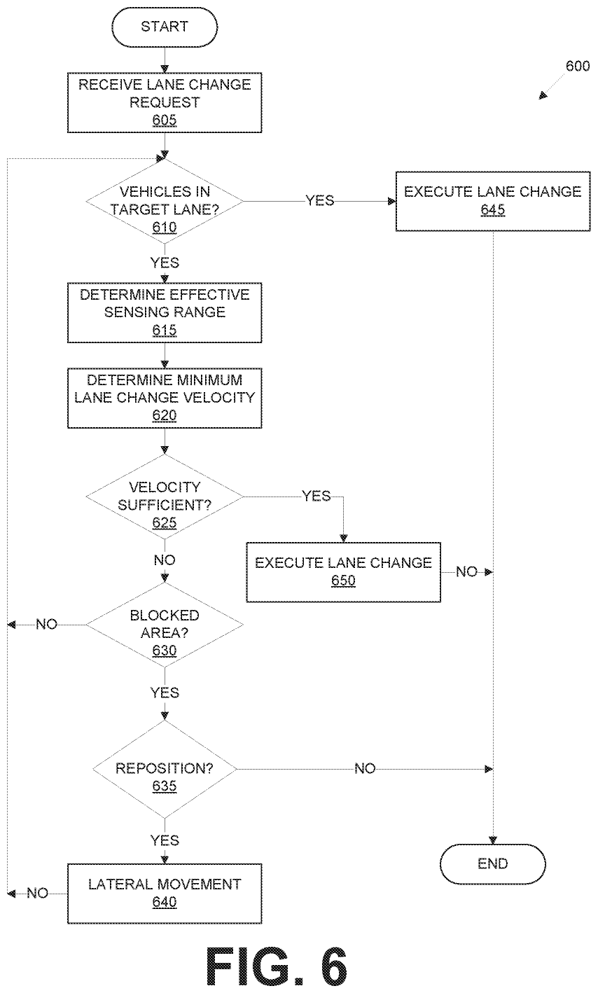

FIG. 6 illustrates a second example process 600 for a host vehicle 100 to determine to change lanes 205, 210. Except for the blocks 615, 620, 625, the process 600 substantially corresponds to blocks of the process 500; therefore, to avoid repetition. the blocks 605, 610, and 630-650 will not be described in detail.

In the block 615, which can follow the block 610, the computer 110 determines a range r of a sensor 115 with respect to a target lane 210. The determination of the block 615 is made without reference to vehicle 100 velocity, but rather according to the geometric determinations described above, including Equations (5) and (6).

Next, in a block 620, the computer 110 can determine a vehicle velocity that would be sufficient for a lane change, e.g., according to the equations, e.g., including Equation (4), provided above.

Then, in the block 625, the computer 110 can determine whether a current vehicle 100 velocity is sufficient for a lane change, i.e., equals or exceeds the velocity determined in the block 620. If so, the process 600 can proceed to a block 650. Otherwise, the process 600 can proceed to a block 630.

As mentioned above, after the block 630, the process 600 executes in a manner substantially similar to the process 500.

### CONCLUSION

As used herein, the adverb “substantially” means that a shape, structure, measurement, quantity, time, etc. may deviate from an exact described geometry, distance, measurement, quantity, time, etc., because of imperfections in materials, machining, manufacturing, transmission of data, computational speed, etc.

In general, the computing systems and/or devices described may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OSX and iOS operating systems distributed by Apple Inc. of Cupertino, Calif., the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

Computers and computing devices generally include computer-executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Python, Matlab, Simulink, Stateflow, Visual Basic, Java Script, Perl, HTML, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random access memory, etc.

Memory may include a computer-readable medium (also referred to as a processor-readable medium) that includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of an ECU. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

With regard to the media, processes, systems, methods, heuristics, etc. described herein, it should be understood that, although the steps of such processes, etc. have been described as occurring according to a certain ordered sequence, such processes may be practiced with the described steps performed in an order other than the order described herein. It further should be understood that certain steps may be performed simultaneously, that other steps may be added, or that certain steps described herein may be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

Wat is claimed is:

1. A method, comprising:
upon receiving a request to change lanes, determining that a first sightline toward a target lane is blocked; and
controlling a vehicle to move laterally in a current lane to obtain a second sightline toward the target lane.

2. The method of claim 1, further comprising
determining, after the vehicle has moved laterally in the current lane, that the second sightline is blocked; and
then suppressing the request to change lanes.

3. The method of claim 1, further comprising
determining, after the vehicle has moved laterally in the current lane, that the second sightline is clear; and
then controlling the vehicle to move to the target lane.

4. The method of claim 1, further comprising determining whether the second sightline is clear for a range of a sensor from which the second sightline originates.

5. The method of claim 4, wherein the range is determined based in part on an ambient condition.

6. The method of claim 4, wherein the range is determined based in part on a predicted maximum deceleration of a second vehicle in the target lane.

7. The method of claim 1, wherein the first and second sightline originate from a sensor mounted to the vehicle.

8. The method of claim 7, wherein the sensor is a radar.

9. The method of claim 1, further comprising, before determining that the first sightline is blocked, that the vehicle is travelling above a specified velocity.

10. The method of claim 1, wherein the request to change lanes is provided from a computer in the vehicle without user input.

11. A system, comprising a computer including a processor and a memory, the memory storing instructions executable by the processor to:
upon receiving a request to change lanes, determine that a first sightline toward a target lane is blocked; and
control a vehicle to move laterally in a current lane to obtain a second sightline toward the target lane.

12. The system of claim 11, the instructions further comprising instructions to
determining, after the vehicle has moved laterally in the current lane, that the second sightline is blocked; and
then suppressing the request to change lanes.

13. The system of claim 11, the instructions further comprising instructions to
determine, after the vehicle has moved laterally in the current lane, that the second sightline is clear; and
then control the vehicle to move to the target lane.

14. The system of claim 11, the instructions further comprising instructions to determine whether the second sightline is clear for a range of a sensor from which the second sightline originates.

15. The system of claim 14, wherein the range is determined based in part on an ambient condition.

16. The system of claim 14, wherein the range is determined based in part on a predicted maximum deceleration of a second vehicle in the target lane.

17. The system of claim 11, wherein the first and second sightline originate from a sensor mounted to the vehicle.

18. The system of claim 17, wherein the sensor is a radar.

19. The system of claim 11, the instructions further comprising instructions to, before determining that the first sightline is blocked, that the vehicle is travelling above a specified velocity.

20. The system of claim 11, wherein the request to change lanes is provided from a computer in the vehicle without user input.
